(19) United States
(12) Patent Application Publication
(10) Pub. No.: US 2014/0047760 A1
(43) Pub. Date: Feb. 20, 2014

(54) FLY SWOOPER

(71) Applicant: Ryan Patrick Coppola, Lucerne, CA (US)

(72) Inventor: Ryan Patrick Coppola, Lucerne, CA (US)

(21) Appl. No.: 13/589,154

(22) Filed: Aug. 19, 2012

(51) Int. Cl. A01M 3/00

(52) U.S. Cl. CPC A01M 3/002
USPC 43/134

(57) ABSTRACT

I would like to start by suggesting that my application be sent to your Tech Department 1700. My invention is a basically net for house flies.

Rigid mesh funnel with a wand like handle attached to the wider rim of the funnel. There is a light weight mesh bag that encloses the spout end of the funnel and is sealed all the way around the rim of wider opening of the funnel. The bag is about as long as handle and is bottom less. A light weight string is sown one inch from the bottom and is tied around the bag, opening and closing the bottom.

### MANUFACTURING

It could be constructed out of plastic using a mold for the funnel and handle. Or it could be constructed naturally with palm leaves woven into a funnel and a bamboo handle, I am envisioning three models, one cheap mass produced plastic, another made hand made by villagers of a natural construction, and one deluxe model, focusing on quality and modern ascetics, with a mailable funnel opening allowing for customization. I have made several functional prototypes with mesh, adhesive putty, semi-rigid plastic mesh normally used for cross-stitching , and a bamboo handle for less than a fifty cents per swooper. The Fly Swooper is more effective, humane, and sanitary than the traditional fly swatter. This invention has very low manufacturing costs and is marketable to every abode in the world.

### USE

Used like a fly swatter but instead of squashing flies against an object in your home, you net and trap them in one motion, so they can be released un-harmed outdoors. The files are swooped through the funnel, which traps them in the net bag and are unable to find their way back out through funnel hole. The flies are then released outdoors by untying the string on the bag which opens the hole in the bottom.

### CROSS REFERENCE TO RELATED APPLICATIONS

None

### BACKGROUND OF THE INVENTION

This invention falls into the categories of household utensils 11.09.25. I have no references to specific documents which I know to be related to my invention. There were no specific problems involved in the creation of my prototype. I have made various size and shaped funnels and they are all very effective.

### SUMMARY OF THE INVENTION AND DETAILED DESCRIPTION

The Fly Swooper is a funnel shaped net that can catch and trap flies in one motion. The Fly Swooper has many advantages over the traditional fly swatter. The Fly Swooper can neutralize flies in mid-air, which is more fun and time efficient than using a swatter. It is also more effective in that it allows for a faster more natural swinging motion, as opposed to hitting, squashing them on whatever object the fly chooses to land on. I captured seven flies in one minute with one of my prototypes today. Releasing them outside un-harmed them felt good, the flies were gone with no bad karma or mess. Flies carry pathogens all over their bodies and transfer easily communicable diseases in a matter of seconds. House flies are known spread typhoid, cholera, dysentery, salmonella, anthrax, tuberculosis and the eggs of parasitic worms. Squashing them all over your house is unsanitary. My invention greatly improves human living conditions, in the indoor environment where people today spend the majority of their time. Who knows how many cases of illness have originated from fly remains or fly swatters, with my invention there are no remains to clean up. This is why I have petitioned for an accelerated or priority examination. The Fly Swooper is Humane, and will be cherished by Buddhists for years to come. I invented this a while ago in order to solve my house fly problem while living on a horse ranch. I wanted to get rid of all the flies inside without harming them, a concern shared by spiritual people world wide. In solving this universal karmic dilemma I actually created a product that is vastly more efficient than anything presented to me on store shelves. Even if one does not share my spiritual views, when the pros and cons of each available solution are weighed, like ascetics and use of chemicals, my swooper still comes out on top. The Fly Swooper is superior in every way. My invention is a money maker, it is very cheap and easy to manufacture thus affordable, light weight to ship and a valuable utensil, marketable to every domicile in the world for reasons ranging from health to amusement. I heard one requirement for obtaining a patent is a potential for profit so I have given my opinion to assert its value, but with sincerity.

### DESCRIPTION OF DRAWINGS

FIG. 1 A: side view (a.) 5 inch string sown to mesh bag {un-tied in drawing} (b.) handle (c.) rigid mesh funnel (d.) light weight mesh bag (e.) smaller opening of funnel (f.) larger opening of funnel, fly entry point and seal that connects bag to funnel (g.) fly exit point and bottom of mesh bag {open in drawing}

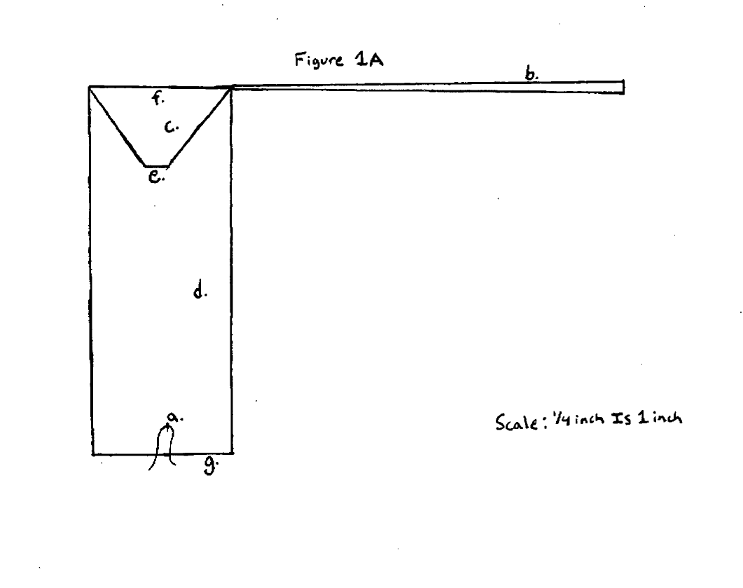

The invention claimed is:

1. A light weight hand held device with a wand like handle for capturing flying insects un-harmed, comprising of a surface that directs insects into a large opening, down through a small opening and into an enclosure that surrounds but does not touch the small opening and exterior of the directing surface, except around the rim of its larger opening.

2. A device as recited in claim 1 wherein said enclosure has a second opening that can be kept closed.
